(19) United States
(12) Patent Application Publication
(10) Pub. No.: US 2009/0035207 A1
(43) Pub. Date: Feb. 5, 2009

(54) METHOD AND DEVICE FOR SEPARATING A GAS MIXTURE

(75) Inventor: Bernd KLEIN, Muenchen (DE)

Correspondence Address: CROWELL & MORING LLP;INTELLECTUAL PROPERTY GROUP, P.O. BOX 14300, WASHINGTON, DC, 20044-4300, US

(73) Assignee: Linde Aktiengesellschaft, Munich (DE)

(21) Appl. No.: 12/031,537

(22) Filed: Feb. 14, 2008

(30) Foreign Application Priority Data
Feb. 15, 2007 (DE) 10 2007 007 581.4

(51) Int. Cl. C01B 31/20; B01D 53/00

(52) U.S. Cl. 423/437.1; 55/342.2

(57) ABSTRACT

A method and device for producing a carbon dioxide product from a feed gas comprised predominantly of carbon dioxide and nitrogen in a cryogenic gas separation process is disclosed. The nitrogen is separated from carbon dioxide in a one-stage condensation process in two separators that are connected in series.

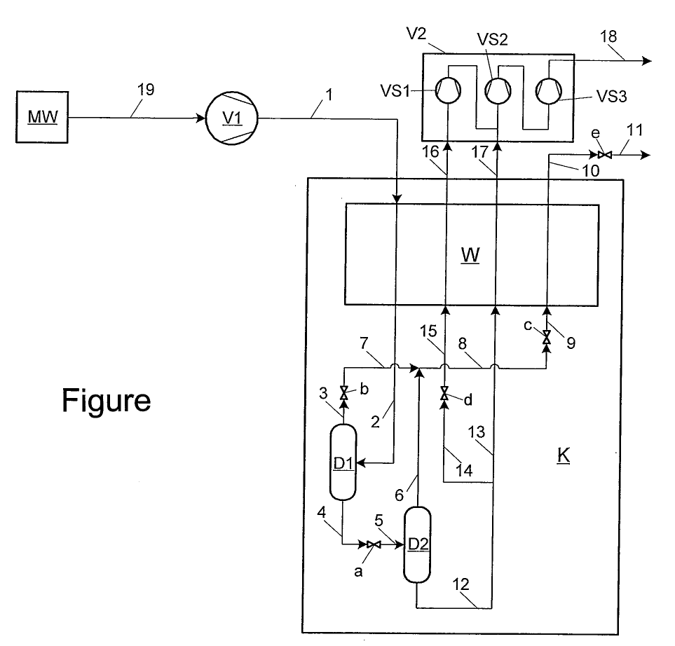

This application claims the priority of German Patent Document No. 10 2007 007 581.4, filed Feb. 15, 2007, the disclosure of which is expressly incorporated by reference herein.

### BACKGROUND AND SUMMARY OF THE INVENTION

The invention relates to a method for producing a carbon dioxide product from a feed gas comprised predominantly of carbon dioxide (CO₂) and nitrogen (N₂) in a cryogenic gas separation process as well as a device for performing the method.

Separating carbon dioxide (CO₂) from gas mixtures containing CO₂ is frequently necessary in industrial processes. For example, crude synthesis gases, which are produced on a large-scale in gasification plants from carbon and/or hydrocarbon feedstocks, e.g., by reforming with water vapor or by partial oxidation, also contain a substantial amount of CO₂ (which must be removed from the crude synthesis gas) in addition to the desired constituents of hydrogen (H₂) and carbon monoxide (CO).

Subjecting the crude synthesis gases to physical gas scrubbing is the state of the art in this case, whereby the CO₂ is separated from the crude synthesis gas with a physically active washing agent. These methods are offered since crude synthesis gases are produced nowadays for the most part under high pressure and the effectiveness of physical gas scrubbing increases as a first approximation linearly with the operating pressure.

Of particular significance for the cleaning of crude synthesis gases is the methanol wash, in which cryogenic methanol is used as the washing agent. It utilizes the fact that the solubility coefficient of CO₂ differs from the solubility coefficients of H₂ and CO in cryogenic methanol by several orders of magnitude. Thus, CO₂ can largely be selectively separated from crude synthesis gases in a methanol wash since it dissolves considerably better in cryogenic methanol than H₂ and CO. The methanol that is loaded with CO₂ during the gas scrubbing is regenerated and fed back to the process.

To separate CO₂ from the loaded methanol, the washing agent regeneration of a methanol wash frequently includes stripping, in which nitrogen (N₂) is used as a strip gas. According to the prior art, the gas flow that is produced in the process, a CO₂-rich gas mixture with a typical N₂ proportion of 15% by volume, is fed as tail gas to the periphery of the system and released there into the atmosphere without being used economically.

The present invention is based on the objective of disclosing a method of the type cited at the outset as well as a device for performing the method, with which it is possible to produce an economically viable carbon dioxide product with low equipment and financial expenditures from a tail gas containing carbon dioxide and nitrogen.

This objective is attained with the method in accordance with the invention in that the method features the following procedural steps:

a) production of a first two-phase mixture by cooling the feed gas against the to-be-evaporated and/or to-be-heated process flows in a heat exchanger;

b) separation of the first two-phase mixture in a first separator into a first N²-rich gas phase containing carbon dioxide and a first CO₂-rich liquid phase containing nitrogen;

c) production of a second two-phase mixture by expanding the first CO₂-rich liquid phase containing nitrogen via a restrictor element;

d) separation of the second two-phase mixture in a second separator into a second N₂-rich gas phase containing carbon dioxide and a second liquid phase featuring carbon dioxide product quality;

e) expansion of the first N₂-rich gas phase containing carbon dioxide via a second restrictor element and merging of the expanded first and second N₂-rich gas phases containing carbon dioxide into a third N₂-rich gas phase containing carbon dioxide;

f) production of the peak cold for the gas separation process by the cold-generating expansion of the third N₂-rich gas phase containing carbon dioxide via a third restrictor element, whereby the expansion is performed in such a way that no solid matter is formed;

g) heating of the material flow obtained by the expansion of the third N₂-rich gas phase containing carbon dioxide against the to-be-cooled feed gas;

h) cold-generating expansion of at least one part of the second liquid phase featuring carbon dioxide product quality via a fourth restrictor element, whereby the expansion is performed in such a way that no solid matter is formed;

i) evaporation and heating of the third two-phase mixture arising from the expansion of the liquid phase featuring carbon dioxide product quality via the fourth restrictor element against the to-be-cooled feed gas;

j) evaporation and heating of the non-cold-generating expanded part of the second liquid phase featuring carbon dioxide product quality against the to-be-cooled feed gas;

k) merging of the gas phases featuring carbon dioxide product quality that were produced during the procedural steps i) and j) into a carbon dioxide product.

Additional embodiments of the inventive method provide that:

the feed gas is produced by compression of a gas comprised predominantly of carbon dioxide and nitrogen;

each of the gas phases featuring carbon dioxide product quality are fed to a CO₂ compressor featuring at least two compressor sections (VS1, VS2) on the intake side of the respective other compressor section and compressed to product pressure; and

a tail gas containing carbon dioxide and nitrogen from the washing agent regeneration of a methanol wash is used as the feed gas.

The stated objective is attained with the device in accordance with the invention in that it is comprised of the following devices:

a) a heat exchanger, in which a first two-phase mixture can be produced from the feed gas by cooling against the to-be-evaporated and/or to-be-heated process flows;

b) a first separator, in which the first two-phase mixture can be separated into a first N₂-rich gas phase containing carbon dioxide and a first CO₂-rich liquid phase containing nitrogen;

c) a first restrictor element, via which the first CO₂-rich liquid phase containing nitrogen can be expanded, whereby a second two-phase mixture is created;

d) a second separator, in which the second two-phase mixture can be separated into a second N₂-rich gas phase containing carbon dioxide and a second liquid phase featuring carbon dioxide product quality;

e) a second restrictor element, via which the first N₂-rich gas phase containing carbon dioxide can be expanded to the pressure of the second N₂-rich gas phase containing carbon dioxide;

f) a third restrictor element, via which a third N₂-rich gas phase containing carbon dioxide that is produced by the combination of the first and the second N₂-rich gas phases containing carbon dioxide can be expanded in a cold-generating manner to produce peak cold for the gas separation process;

g) a fourth restrictor element, via which at least one part of the second liquid phase featuring carbon dioxide product quality can be expanded in a cold-generating manner;

h) the piping connecting the aforementioned device features;

i) a heat-insulated enclosure (coldbox) (K), in which the aforementioned device features are arranged.

Additional embodiments of the inventive device provide that:

a compressor is arranged outside the coldbox, in which the feed gas can be produced by compression of a gas comprised predominantly of CO₂ and N₂; and

a CO₂ compressor featuring at least two compressor sections is arranged outside of the coldbox, to which compressor the gas phases featuring carbon dioxide product quality and exiting the coldbox with different pressures can be fed on the intake sides of the respective other compressor sections.

The invention provides a cost-effective possibility of separating nitrogen from a CO₂/N₂ mixture up to a residual content of under 3% by volume.

In so-called enhanced oil recovery (EOR) methods, carbon dioxide is injected into oil deposits in order to increase the yield of the oil production. The carbon dioxide used for this should have a N₂ content of less than 3% by volume. As a result, the invention is especially suited for producing a carbon dioxide product, which can be used in a so-called EOR method, from a feed gas containing carbon dioxide and nitrogen, in particular from the tail gas of washing agent regeneration of a methanol wash.

### BRIEF DESCRIPTION OF THE DRAWING

The FIGURE illustrates an embodiment of the device and method of the present invention.

### DETAILED DESCRIPTION OF THE DRAWING

The exemplary embodiment relates to a device for producing a carbon dioxide product from tail gas containing carbon dioxide and nitrogen from the washing agent regeneration of a methanol wash.

The tail gas 19 containing carbon dioxide and nitrogen that exits in an almost unpressurized manner from the washing agent regeneration of the methanol wash MW is fed to the compressor V1 and compressed there to a pressure of approx. 40 bar(a). The gas exiting from the compressor V1 is guided as feed gas into the coldbox K and fed to the warm end of the heat exchanger W. The feed gas 1 is cooled in the heat exchanger W against the to-be-heated and to-be-evaporated process flows to a temperature of approx. −40° C. and partially liquefied in the process. The two-phase mixture produced in this manner is withdrawn from the heat exchanger W via line 2 and guided to the separator D1, where it is separated into a first N₂-rich gas phase containing carbon dioxide and a first CO₂-rich liquid phase containing nitrogen. The first CO₂-rich liquid phase containing nitrogen is then withdrawn from the separator D1 via line 4 and expanded via the restrictor element a to a pressure of approx. 22 bar(a). The second two-phase mixture 5 generated by the expansion via the restrictor element a is guided to the second separator D2, where it is separated into a second N₂-rich gas phase containing carbon dioxide and a second liquid phase featuring carbon dioxide product quality.

The first N₂-rich gas phase containing carbon dioxide is withdrawn from the first separator D1 via line 3 and expanded via the restrictor element b in the line 7 to the pressure of the second N₂-rich gas phase containing carbon dioxide that was withdrawn from separator D2. The two gas phases 6 and 7 are combined into a third N₂-rich gas phase 8 containing carbon dioxide, which is then expanded in a cold-generating manner via the restrictor element c to produce peak cold for the gas separation process. In order to prevent blockages in the channels of the heat exchanger W, this cold-producing expansion takes place at a pressure that is high enough to prevent solid matter waste in the expanded material flow 9. The N₂-rich material flow 9 containing carbon dioxide is heated in the heat exchanger W against the to-be-cooled feed gas 1, fed out of the coldbox K via line 10 and, after expansion via the restrictor element e, conveyed at a predetermined pressure level via line 11 as so-called N₂ waste to the periphery of the system.

The second liquid phase featuring carbon dioxide product quality is fed out of the separator D2 via line 12 and divided into two partial flows 13 and 14. While partial flow 13 is then conducted in a direct route to the cold end of the heat exchanger W, partial flow 14 is expanded in a cold-generating manner via the restrictor element d to approx. 12 bar(a) and afterwards fed to the heat exchanger W via line 15. The size of the partial flow 14 is adjusted in such a way that the unavoidable cold losses of the method are covered. The two partial flows 13 and 15 are then evaporated and heated in the heat exchanger W against the feed gas 1 and guided out of the coldbox K in a gaseous manner via lines 16 and 17.

The gas flow 16 featuring carbon dioxide product quality is then fed to the product compressor V2 at the intake side of the first compressor section VS1, while the gas flow 17, which also features carbon dioxide product quality and whose pressure is higher than that of the gas flow 16, is fed to the product compressor V2 at the intake side of the second compressor section VS2. The two gas flows are jointly compressed in the third compressor section VS3 to the product pressure and conveyed as carbon dioxide product via line 18 to the periphery of the system.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for producing a carbon dioxide product from a feed gas comprised predominantly of carbon dioxide and nitrogen in a cryogenic gas separation process, comprising the steps of:
a) production of a first two-phase mixture by cooling the feed gas against a to-be-evaporated and/or a to-be-heated process flow in a heat exchanger;
b) separation of the first two-phase mixture in a first separator into a first N₂-rich gas phase containing carbon dioxide and a first CO₂-rich liquid phase containing nitrogen;
c) production of a second two-phase mixture by expanding the first CO₂-rich liquid phase containing nitrogen via a restrictor element;
d) separation of the second two-phase mixture in a second separator into a second N₂-rich gas phase containing carbon dioxide and a second liquid phase featuring carbon dioxide product quality;
e) expansion of the first N₂-rich gas phase containing carbon dioxide via a second restrictor element and merging of the expanded first and the second N₂-rich gas phase containing carbon dioxide into a third N₂-rich gas phase containing carbon dioxide;
f) production of a peak cold for the gas separation process by cold-generating expansion of the third N₂-rich gas phase containing carbon dioxide via a third restrictor element, wherein the expansion is performed in such a way that no solid matter is formed;
g) heating of a material flow obtained by the expansion of the third N₂-rich gas phase containing carbon dioxide against the to-be-cooled feed gas;
h) cold-generating expansion of at least one part of the second liquid phase featuring carbon dioxide product quality via a fourth restrictor element, wherein the expansion is performed in such a way that no solid matter is formed;
i) evaporation and heating of a third two-phase mixture arising from the expansion of the at least one part of the second liquid phase featuring carbon dioxide product quality via the fourth restrictor element against the to-be-cooled feed gas;
j) evaporation and heating of a non-cold-generating expanded part of the second liquid phase featuring carbon dioxide product quality against the to-be-cooled feed gas; and
k) merging of gas phases featuring carbon dioxide product quality that were produced during the steps i) and j) into a carbon dioxide product.

2. The method according to claim 1, wherein the feed gas is produced by compression of a gas comprised predominantly of carbon dioxide and nitrogen.

3. The method according to claim 1, wherein each of the gas phases featuring carbon dioxide product quality are fed to a CO₂ compressor featuring at least two compressor sections on an intake side of a respective compressor section and compressed to product pressure.

4. The method according to claim 1, wherein a tail gas containing carbon dioxide and nitrogen from a washing agent regeneration of a methanol wash is used as the feed gas.

5. A device for producing a carbon dioxide product from a feed gas comprised predominantly of carbon dioxide and nitrogen in a cryogenic gas separation process, comprising:
a) a heat exchanger, in which a first two-phase mixture is produced from the feed gas by cooling against a to-be-evaporated and a to-be-heated process flow;
b) a first separator, in which the first two-phase mixture is separated into a first N₂-rich gas phase containing carbon dioxide and a first CO₂-rich liquid phase containing nitrogen;
c) a first restrictor element, via which the first CO₂-rich liquid phase containing nitrogen is expanded and wherein a second two-phase mixture is created;
d) a second separator, in which the second two-phase mixture is separated into a second N₂-rich gas phase containing carbon dioxide and a second liquid phase featuring carbon dioxide product quality;
e) a second restrictor element, via which the first N₂-rich gas phase containing carbon dioxide is expanded to a pressure of the second N₂-rich gas phase containing carbon dioxide;
f) a third restrictor element, via which a third N₂-rich gas phase containing carbon dioxide that is produced by a combination of the first and the second N₂-rich gas phases containing carbon dioxide is expanded in a cold-generating manner to produce peak cold for the gas separation process;
g) a fourth restrictor element, via which at least one part of the second liquid phase featuring carbon dioxide product quality is expanded in a cold-generating manner;
h) piping connecting the aforementioned device features; and
i) a heat-insulated enclosure, in which the aforementioned device features are arranged.

6. The device according to claim 5, further comprising a compressor arranged outside the heat-insulated enclosure, in which the feed gas is produced by compression of a gas comprised predominantly of CO₂ and N₂.

7. The device according to claim 5, further comprising a CO₂ compressor featuring at least two compressor sections arranged outside of the heat-insulated enclosure, to which compressor gas phases featuring carbon dioxide product quality and exiting the heat-insulated enclosure with different pressures are fed on an intake side of a respective compressor section.
